(19) United States
(12) Patent Application Publication
(10) Pub. No.: US 2011/0182687 A1
(43) Pub. Date: Jul. 28, 2011

(54) Novel method of automating the operation of a machine tool

(76) Inventor: David James Munz, East Rockaway, NY (US)

(21) Appl. No.: 12/657,653

(22) Filed: Jan. 25, 2010

(51) Int. Cl. B23Q 3/06

(52) U.S. Cl. 409/225

(57) ABSTRACT

The majority of computer controlled machining centers lack any provision for loading individual parts onto the machine for future machining operations and lack the ability to remove these same parts after machining operations commence. A mechanism which fits into the spindle of existing machine tools and harnesses the energy to the rotating spindle to grip parts facilitates automated machine tool operation without making significant changes to the architecture of the machine tool or requiring the addition of an external part loading device. Parts awaiting machining operations can be arranged on the table of the machine tool, stacked on the machine table, fed via a chute to the machine tool, or fed using some other traditional method of parts feeding. To further facilitate automated machine operations, dedicated tool holders for taping and drilling operations may be equipped with reservoirs containing cutting fluid which is dispensed when the spindle is rotated sufficiently fast before being stopped.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### (1) FIELD OF THE INVENTION

The invention relates to a method of automating the operation of computer controlled machining centers by harnessing spindle rotation energy as a means of selectively moving a work piece to and from the machine and applying cutting fluid as necessary in machining operations performed on the work piece.

### (2) DESCRIPTION OF RELATED ART

Automated machine tools for conducting machining operations are in existence and function in a manor analogous to the content of this patent. Existing patents document the use of spindle mounted gripping devices to grasp parts in order to place them in the fixtures necessary to machine them. Gripping devises powered by mechanisms integrated into the design of the machine tool and control is well documented. Part gripping devices powered by the flow of high pressure machine coolant into the device are widely available for machine tools equipped with provisions to flow coolant through the spindle of the machine tool, and lathes with provisions to flow coolant into the tool holder onto which the gripping device is affixed. The majority of vertical machine tools lack the provisions necessary to flow the pressurized coolant thru the spindle necessary to activate these gripping devices. Dedicated machine tools in which a part is moved between several stations in which individual machining operations are performed are available but their dedicated design makes them expensive, and too inflexible to reasonably accommodate the manufacture of different parts.

U.S. Pat. No. 4,555,047 describes a tool holder type device which applies lubricant contained in the holder to a tapped hole when the nose of the device is pressed against the hole. There is no capability of this device to function as an actual tool holder capable of performing machine work on the part being lubricated.

U.S. Pat. No. 6,772,042 describes a programmable coolant nozzle capable of dispensing coolant to a specific portion of a cutting tool dependent on pre programmed parameters.

U.S. Pat. No. 4,439,090 describes a dedicated work piece gripper used to move a machine part on a computer controlled lathe. Its function is indicative of dedicated work piece movers which are integrated into the design of a machine tool. Such a design could not be reasonably retrofitted to an existing machine.

U.S. Pat. No. 4,359,815 describes a robot interfaced with a computer controlled machine tool. While such systems exists, they are too complex and expensive for a majority of machine shops to operate.

U.S. Pat. No. 5,803,886 describes a spindle mounted part gripper with a proprietary interface to the machine tool to provide the gripper with pressurized hydraulic fluid to operate the gripper. Such a system would be difficult to retrofit to an existing machining center.

http://emachineshops.com/news/125/ARTICLE/1096/2008-04-15.html describes the usage of thru spindle coolant pressure to activate a part gripper manufactured by Benz, Inc. Usage of such a product is restricted to machines equipped with thru spindle coolant.

### Objects and Advantages

Automated machine tools with provisions to load and unload parts with minimal operator intervention are customary in high volume applications where sufficient workload justifies the expense of such specialized pieces of equipment. Machines designed without the intention of automated operation may be retrofitted to perform automated operations at considerable expense using exchangeable pallets to which parts must still be manually loaded to the pallet by an operator, or by using a programmable robot to load and unload parts in a manner analogous to how a human would operate the machine. These two alternative methods of automating an existing machine tool have the significant drawback of requiring that the part loading mechanism to interface with the existing machine control. Existing machine controls often lack provisions to input or output data so the control must be upgraded or replaced at considerable expense. To alleviate these barriers to machine tool automation, several manufactures market part grippers which mount in the spindles of machine tools in the same manner as a traditional cutting tool would. To open and close these part grippers, the power of thru spindle coolant systems capable of delivering high pressure coolant trough the spindle is harnessed. The obvious disadvantage of this approach is that high pressure thru spindle coolant must be integrated into the architecture of the machine tools being retrofitted. Retrofitting such a thru spindle coolant system to a machine tool without it is considerably expensive.

This novel part gripping device harnesses rotational spindle energy to open and close the part gripper allowing for its operation on machine tools with limited machine controls and no provision for thru spindle coolant. The part gripping device mounts to the spindle taper in the same manner as other tools in the machine would. Depending on how the gripper captures spindle energy and the nature of the parts being gripped, some provision to prevent the body of the part gripper from rotating in sync with the spindle may be necessary. It is common practice when using right angle attachments and speeder heads which mount in the spindles of machine tools for some provision to exist, usually in the form of a small nub to exist at the base of the spindle, in order to prevent the attachment from rotating in sync with the spindle. The ultimate embodiment of this automation concept is the device documented in this patent which processes the capability to both grip and machine parts using a cutting tool integrated into the design of the part gripper. Such a device would facilitate the automated production of machined parts on a machine lacking the necessary provisions to change cutting tools in the machine.

A traditional machine tool operator performs many functions in addition to placing and removing work in the machine. Parts with tapped or drilled holes often require that a cutting lubricant be squirted on the cutting tool prior to machining operations. Some machine tools are already equipped with integrated devices mounted in close proximity to the machine's spindle that are capable of squirting a small quantity of lubricant from a machine mounted reservoir onto the cutting tool. It is difficult or impossible to retrofit such functions onto machine with out integrated systems as the squirting nozzle must be programmed to administer lubricant at different locations dependent on the length of the individual cutting tool. A system capable of compensating for the various length tools requires specialized control function not available on the majority of machine tool controls. Existing patents on these devices restrict the manufacture of retrofitted mechanisms similar to those already integrated into available machine tools. In lei of these systems, a tool holder capable of holding and administering cutting lubricant has the advantage of being configured to properly administer the correct quantity of fluid to the correct portion of the individual tool contained in said tool holder. Such a tool holder functions universally in all machine tools regardless of whether the machine tool lacks any system to, selectively administer cutting fluid. As with the part gripper described in this patent, the tool holder harnesses spindle energy, which provides the energy to expel the fluid from the reservoir integrated into the body of the cutting tool. Individual tool holders contain their own fluid medium so fluids can be selected based on the needs of the individual tool mounted in the holder.

Rotational spindle energy may be harnessed to grip a work piece using a variety of methods. In applications where larger parts are being held or parts are to be held in the machine tool's spindle while machining operations are performed on them a form of hydraulic clamping in which a hydraulic pump driven by the rotating spindle pumps hydraulic fluid to either a hydraulic piston, pistons, or some hydraulic motor arrangement to generate the clamping pressure capable of securely holding the part to the spindle of the machine tool. Auxiliary cutting tools could be arranged on the table of the machine tool in a manner analogous to how life tool holders function in a computer controlled live spindle turret lathe. The type of tooling, orientation of the tool on the machine table, and the rotational speed of the individual tool could be optimized for its individual machining function on the work piece. A computer controlled machine tool functioning in this manner could quickly perform a variety of operations on a work piece without having to spend time changing tools. Since tools could be oriented to drill holes from a variety of different angles, all machining operations could be conducted with a minimum amount of setups. A machine set up in this manner would be a compromise between a standard computer controlled machining center and a dedicated production machine. Older machine tools with slow tool changers and slow rapid table movements could become efficient production machines with the addition of work piece grippers and auxiliary machine spindles mounted to the table of the machine tool.

On machine tools with the capability to selectively index the spindle of the machine tool there exists the capability to directly couple the rotation of the part gripper to the movement of the actual mechanism which grabs the part. Such a design would minimize part gripper complexity and cost. An additional benefit would be that gripping force could be correlated to the amount of spindle rotation.

Where machine tool spindles can not be selectively indexed by a control function, a friction based slipper clutch could be utilized to provide an inexpensive simple method to coupling the rotating spindle motion to the rotating part grippers which hold the part being moved. Friction based slipper clutches have the advantage of having adjustable preload which regulates the amount of torque they transfer while they are slipping.

A fluid coupling type slipper clutch has the advantage of not wearing out in the same manner as a friction type coupling would. Essentially a self contained hydraulic system, a fluid coupling functions properly regardless of whether it is dry or drenched by a deluge of cutting oil.

Anyone skilled in the art could generate countless ways of mechanically coupling a rotating machine tool spindle to a moving part gripper or grippers. The concept documented in this patent was chosen because it is simple, concise, and simple to manufacture.

A novel incarnation of this invention would be a part gripper in which the gripping mechanism spins freely, but is activated by movement of a weight or weights which rotate along with the spindle and move outward as the spindle rotates. Such a system would work well at lifting and depositing round lathe parts for second operation work on a computer controlled machine tool.

### SUMMARY

The methods described in this document facilitate the inexpensive conversion of traditional computer controlled machining centers from manned to automated operation. Harnessing existing machine control functions over spindle rotation as a means of selectively powering a work piece gripper or tap lubricator significantly reduces the cost and complexity of converting a machining center to automated operation.

### BRIEF DESCRIPTION OF THE DRAWINGS

The following drawing will help to describe by example this invention:

FIG. 1 depicts an isometric view of a part gripping mechanism secured in the spindle of a machine tool with the movable arms capable of gripping a part retracted.

FIG. 2 shows an isometric view of a part gripping mechanism secured in the spindle and gripping a part situated below the cutting tool.

FIG. 3 is a frontal view the same part gripping mechanism mounted in the spindle. Phantom lines convey the paths of travel of the movable gripper arms and gripper contacts.

FIG. 4 is an isometric view of the part gripping mechanism situated some distance below the spindle leaving the interface between the two mechanisms visible.

FIG. 5 depicts an exploded isometric view of some of the components of the part gripping mechanism.

FIG. 6 is an exploded isometric view of the internal workings of the part griping mechanism.

FIG. 7 shows an isometric view of the assembled tap holder with the capability of holding and selectively applying taping fluid.

FIG. 8 is an exploded isometric view of the tap holder assembly.

FIG. 9 is an exploded isometric view of selected parts of the tap holder assembly with phantom lines conveying the internal pathways in the body of the tap holder which facilitate the flow of fluid from the reservoir to the tap.

### REFERENCE NUMERALS

### Detailed Description

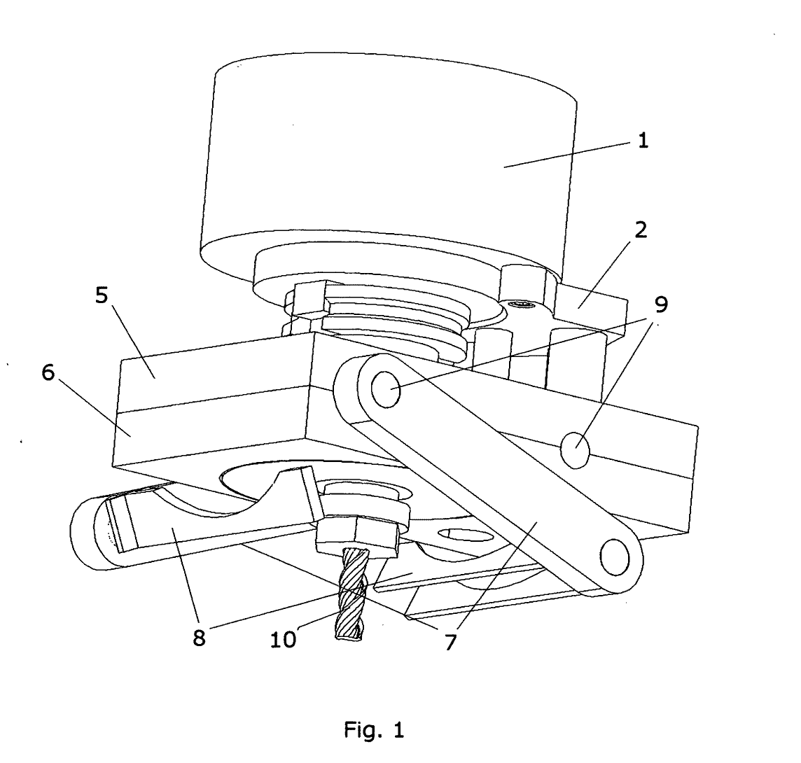

### FIG. 1-FIG. 3—Preferred Embodyment

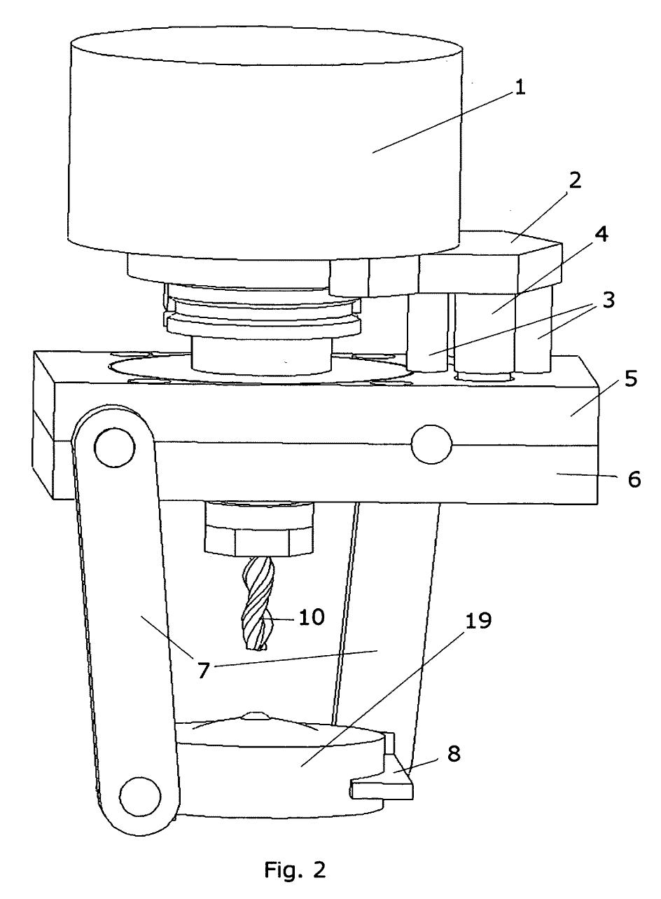

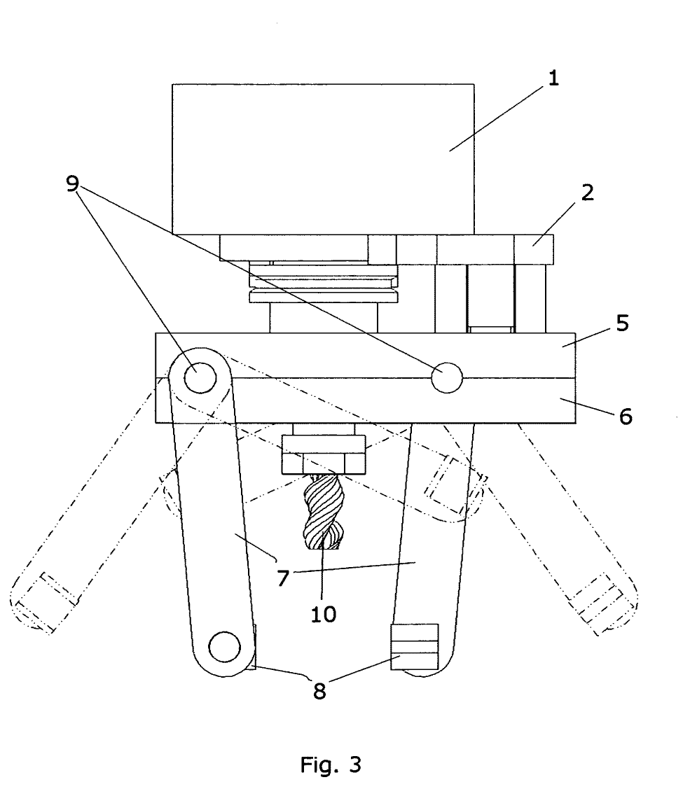

The preferred embodiment of this part gripping mechanism is depicted in FIG. 1 is of the part gripper with its gripping arms 7 and gripper contacts 8 retracted. With the arms 7 in this configuration, sufficient room exists below the arms 7 for the endmill 10 to process machine parts. Each of the two gripper arms are pressed on to one of the two helical gear assemblies 9 which rotate about an axis running through their centerline. The projection lines on FIG. 3 convey the extents to which the arms 7 may move as they rotate in unison with the helical gear assemblies 9. The helical gear assemblies 9 are constrained by channels machined into the mating faces of the upper body 5 and the lower body 6. The upper body 5 and lower body 6 together form the main body of the part gripper containing the mechanisms which center the assembly on the spindle 1 of the machine tool to which the assembly is connected. Sandwiched between the upper body 5 and lower body 6 are all mechanisms which cause the helical gear assemblies 9 to rotate along with the arms 7 and the gripper contacts 8 to articulate. These internal mechanisms not visible in these three views press on to the tool holder 8 depicted in FIG. 2 which mates directly against the internal surface of the spindle 1. A mount 2 rigidly connected to the spindle 1 has two stop 2 members and two plunger 4 members protruding from its underside. The two plunger 4 members are sufficiently long that when the tool holder is inserted into the spindle 1, they slide into two recesses in the upper body 5 and the lower body 6 of the part gripper. The two stop 3 members do not protrude into the upper body 5 and nothing exists on the surface of the upper body 5 to accommodate them. With the tool holder

in direct contact with the internal surface of the spindle 1, the two stop 3 members are in contact with the upper surface of the upper body 5.

FIG. 2 depicts the part gripper securing an actual part 19 between the two gripping contacts 8. Note that the part 19 is secured a sufficient distance below the endmill 10 to accommodate parts 19 of various sizes and orientations. The full extents of arm 7 travel conveyed by FIG. 3 show how the mechanism can accommodate parts of various widths. Additionally, since the gripper contacts 8 are a separate part from the arms 7 to which they attach, the arms can be oriented into different configurations, or replaced with arms 7 of different varieties to accommodate a part 19 or parts 19 of various dimensions.

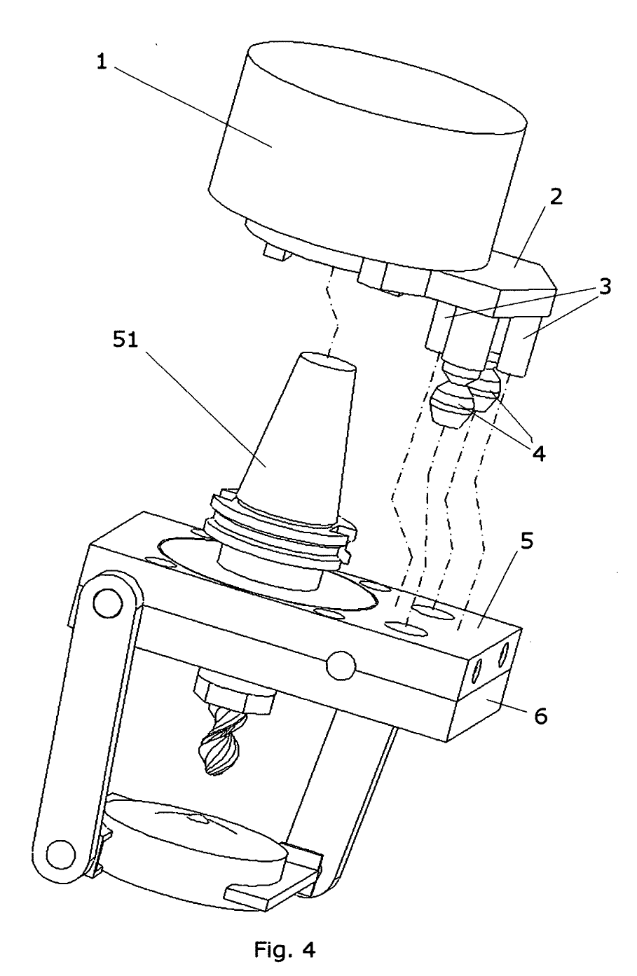

### FIG. 4—Preferred Embodyment

FIG. 4 shows the part gripping mechanism displaced some distance below the spindle 1 of the machine tool to which the part gripping mechanism would be installed in. Visible in this isometric view is the male surface of the tool taper 51 on the part gripper which would contract the female inner surface of the spindle 1. Visible on the upper body 5 of the part gripper are the two recesses into each of which an individual plunger 4 would slide into. Note the profile of an individual plunger with its filleted point to assist it in finding its way into one of the visible recesses cut into the upper body 5 and the recess which also exist in the lower body 6 but are not visible in this drawing. Beyond the filleted base of the plunger 4 is a deep recess. Two spring plungers 20, not visible in this view are screwed into the two threaded holes on the right side of the upper body 5. The spring loaded plunger projections press against the recess turned into the profile of the plunger 4. The two stops 3 contact the top surface of the upper body 5 when the two plungers 4 are pressed into the two recesses in the upper body 5. Securing the two stops 3 and the two plungers 4 to the spindle is a mount 2. Contact between the two stops 3, and the two plungers 4 with the upper body 5, lower body 6, and two spring plungers 20 is sufficient to constrain the relationship between the body of the gripper and the spindle. As such, a loose connection may exist between the internal mechanisms of the gripper and the upper body 5 and lower body 6. This is a critical feature in embodiments of this design where it would be difficult to procure a bearing or bearings to interface between the rotating internal mechanisms of the part gripper and the upper body 5 and lower body 6. If a bearing with sufficient rpm capability, tolerance for machining byproducts, and ability to function with compromised lubrication was available, its addition to the design could significantly increase the cost of manufacture of the mechanism. For embodiments turning at relatively low speeds a bearing interface can be a fruitful proposition.

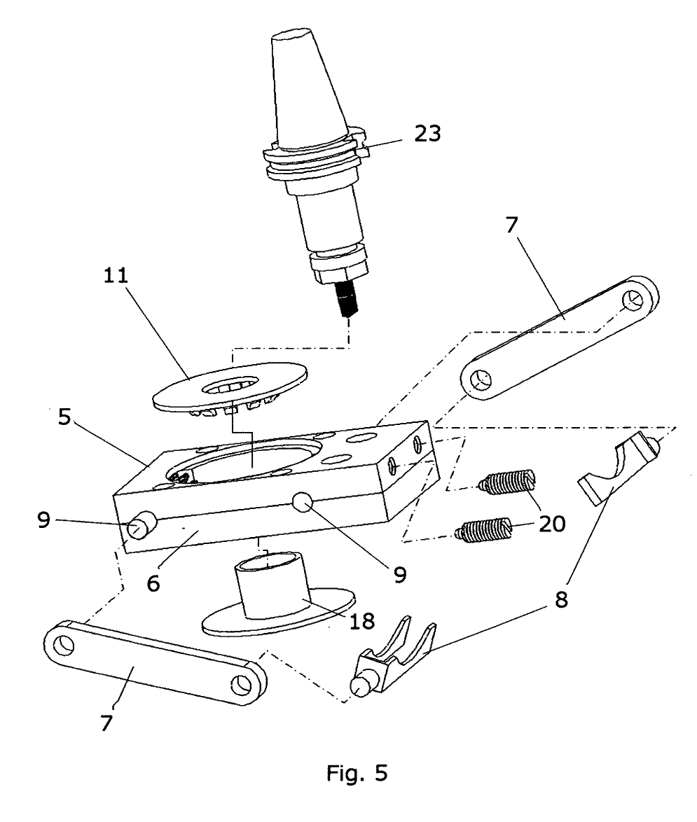

### FIG. 5—Preferred Embodyment

FIG. 5 depicts all components of the part gripper visible on an assembled part gripping mechanism. Note the tool holder 23, a standard tool holder commercially available and a common type of tooling useful on computer controlled machining centers. This particular tool holder 8 utilized an ER type collet secured in an internal tap of the tool holder 23 by a collet nut which threads onto external threads on the tool holder 8. Pressed onto the tool holder is the indented disc 11. The underside of the indented disc fits into a recess in the upper surface of the upper body 5. Pressed between the upper body 5 and the lower body 6 is the helical gear assembly 9. Pressed onto the tool holder below the lower body 6 is the spacer disc. The fit of the spacer disc 18 to the lower body 6 is analogous to the fit of the indented disc 11 to the upper body 5. Note the two spring plungers 20 which thread into the upper body. The projections of the spring plungers 20 face into the two recesses visible in the surface of the upper body. Note how the two arms 7 press onto the two helical gear assemblies 9. The two gripper contacts 8 each press into one of the two arms 7.

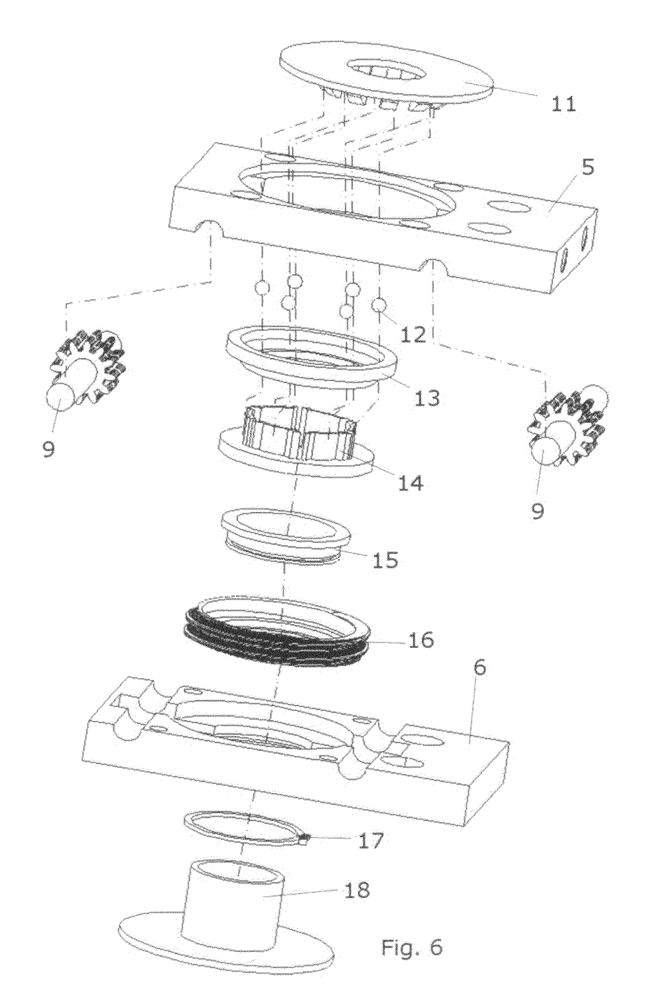

### FIG. 6—Preferred Embodyment

FIG. 6 shows an exploded isometric view of the internal workings of the part gripping mechanism. Note the underside of the indented disc 11 with its notched protrusions pointing downward into the cavity formed between the upper body 5 and the lower body 6. A ball bearing 12 fits into each individual recess of the indented disc 11. The ball bearings 12 have sufficient clearance to fit into the indented disc and still move freely. The ball bearings 12 are held into the notches in the indented disc 11 by the bearing container 13 which presses onto the notched projections on the indented disc 11. The inner surface of the bearing container 13 is filleted at an angle so the bearings roll down its surface to the center of the indented disc 11. The driving plate 14 is situated in between the notched projections of the indented disc 11. The driving plate 14 has a profiled surface with projections which can pinch the individual ball bearings against the vertical walls of the indented disc 11. The bearings 12 pinched between the driving plate 14 and the indented disc 11 convey the rotational motion of the indented disc 11 to the driving plate 14 until sufficient torque exist between the indented disc 11 and the driving plate 14 to free the pinched ball bearings 12. Modifications to the geometry of the indented disc 11 and the driving plate 14 alter the torque transferring capacity of the interface. More torque transferring capacity should be available when the part gripping mechanism is releasing parts than when it is grabbing parts. The driving plate 14 presses into the worm gear 16 so that the worm gear 16 rotates in sync with the driving plate 14. A loose fitting bushing 15 is held captive in a recess formed between the worm gear 16 and the driving plate 14. The loose fitting bushing is secured by a c-clip 17 to the lower body 6 effectively allowing the worm gear 16 and driving plate assembly 14 to rotate about a fixed axis, but constraining the assembly so that the underside of the worm gear 16 remains in direct contact with a surface of the lower body 6. The teeth of the worm gear 16 mesh with the teeth of the two helical gear assemblies 9 which rotate in recesses machinated into the upper body 5 and lower body 6. Rotation of the worm gear 16 causes the helical gear assemblies 9 to rotate in a direction opposite one another.

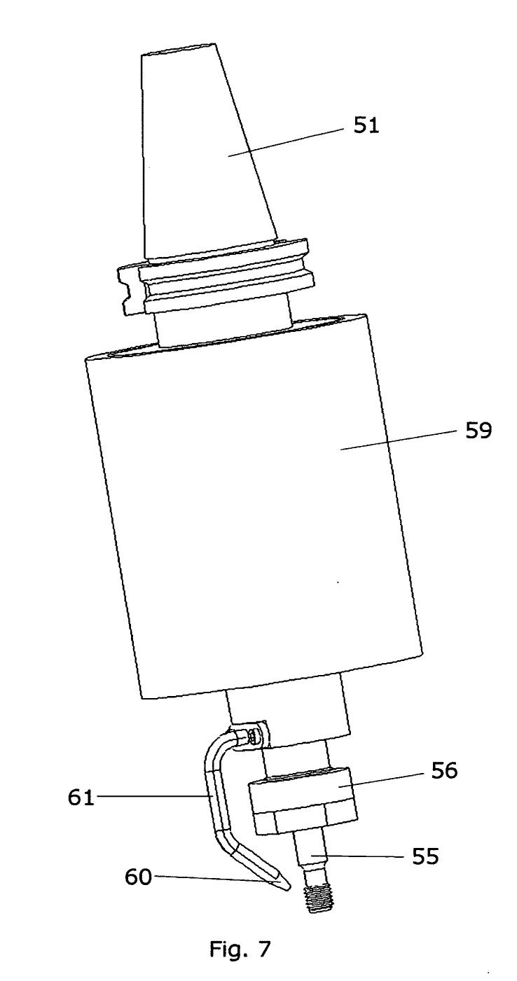

### FIG. 7—Preferred Embodyment

FIG. 7 depicts a tap holder intended to function in conjunction with the part gripper illustrated in FIG. 1 thru FIG. 6. The tap holder has the same tool holder taper 51 as the part gripper and would be useful in automated machining applications where an operator is not available to lubricate a tap during taping operations. Note the large reservoir 59 for containing fluid to be administered on the tap 55 by flowing it through the injector tube 61, and forcing it thru the nozzle 60. The tap holder holds the tap in std industry fashion as evidenced by the exposed collet nut 56.

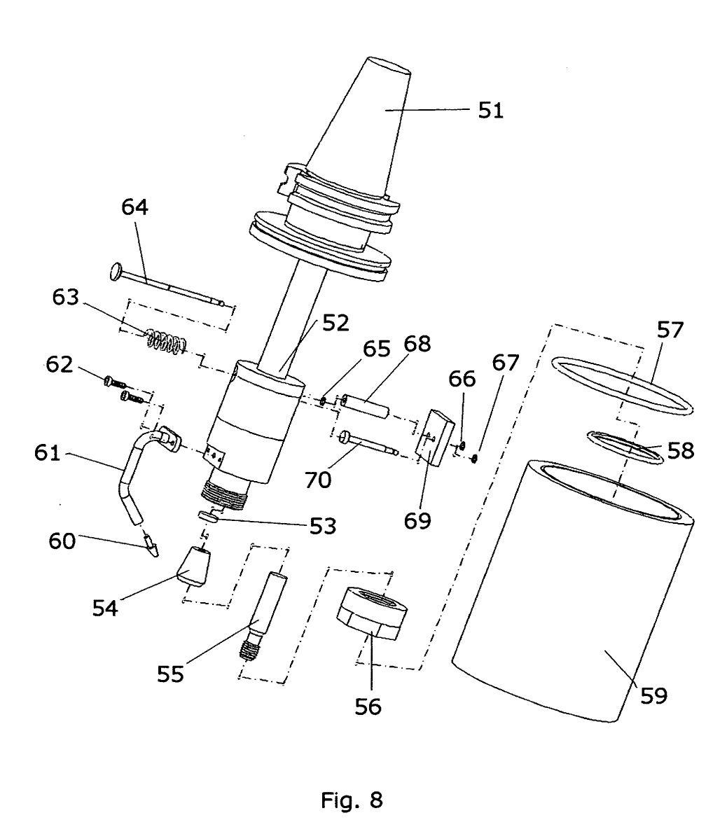

### FIG. 8—Preferred Embodyment

FIG. 8 shows an exploded isometric view of the tap holder. Note the tool holder taper 51 necessary for the taper to interface with a standard machine tool spindle. The narrowed portion of the body 52 of the tool holder maximizes the fluid capacity of the reservoir 59 which fits over the body. Sealing the reservoir to the body is a small o-ring 58 which fits into an internal recess in the open base of the reservoir and seals the base of the reservoir to the body of the tool holder. The large o-ring 57 fits into a groove in the upper portion of the body 52 of the tool holder. Since the base of the reservoir 59 constrains the lower O-ring 58 the reservoir can be slid up and down and the body 52 of the tap holder to create a gap between the top of the reservoir 59 and the body 52 facilitating the addition of fluid to the reservoir. The body 52 is relieved of several internal passages to permit the flow of fluid and movement of two fluid pumping assemblies inside of the body 52. Pressing into the body 52 is the long rod 64. Between the long rod 64 and the body is a compression spring 63 which presses against the body 52 and counters movement of the long rod 64 into the body. A c-clip 65 fits into the groove in the long rod 64 closest to the compression spring 63. The c-clip 65 constrains the movement of the plunger 68 which also presses onto the long rod 64. Pressed onto the long rod 64 immediately after the plunger 68 is a weight 69. A second c-clip 66 presses into a second notch in the long rod 64 and holding all of the components of the members between the two c-clips together on the long rod 64. A short rod plunger 70 attaches to the weight 69 using a third c-clip 67 which holds the weight 69 against a step in the shaft on the short rod plunger 70. The short rod plunger 70 moves in sync with the long rod 64 and the components assembled on it. By virtue of the compression spring 63 pressed between the long rod 64 and the body 52, the equilibrium position of the weight 69 when the tool holder is motionless is with the weight 69 pressed against the body 52. When the tool holder is rotated forces generated by the centripetal accelerations of the weight 69 pull the weight away from the body 52. The fluid pumped by the movement of the plunger 68 travels thru the body 52 to the injector tube 61. Noteworthy is the blockoff plate 53 which presses into the base of the body 52 to close off the internal cavities in the body 52. Allen bolts 62 secure the injector tube 61 to the body 52. A nozzle 60 pressed into the injector tube 61 squirts the fluid traveling thru the body 52. Note that a standard collet 54 holds a tap 55 into the body 52 as the collet nut 56 presses against the collet 54.

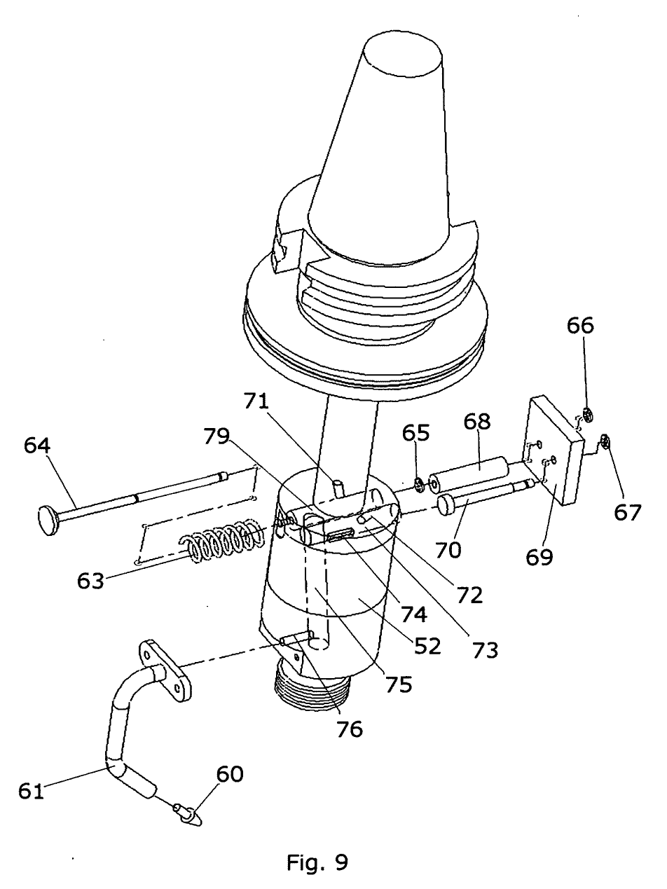

### FIG. 9—Preferred Embodyment

FIG. 9 depicts an exploded isometric view of the tap hole with the internal cavities in the body of the tool holder illustrated by phantom lines. Note that the long rod 64 slides into the long rod cavity 70 with the compression spring 63 between the long rod 64 and the body 52. Pressed onto the long rod are the first c-clip 65, the plunger 68, the weight 69, and c-clip 66. Fluid flows into the long rod cavity 79 thru the long rod inlet 71 when the plunger 68 is pulled in the direction of the weight 69 which moves away from the body 52 when the tool holder is rotated. The short rod plunger 70 also moves in sync with the weight 69. Fluid flows freely into the short rod inlet 72 in route to the short rod circuit 73. When the tap holder stops spinning, the weight 69, pulled by the compression spring 63 moves closer to the body 52. Movement of the plunger closes off the long rod inlet 71 which constrains pressurized fluid between the plunger and ultimately the nozzle 60. Fluid flows from the long rod cavity 79, thru the vertical pathway 75, into the horizontal pathway 76, into the injection tube 61, and squirts out the nozzle 60 to the tap or other cutting tool held in the spindle. Fluid in the short rod cavity 73 is constrained by the short rod plunger 70. Movement of the weight 69 and all that it is attached to is restricted by the relatively slow flow of fluid around the short rod plunger 70. When the assembly moves appreciably enough for the cavity 74 to provide an easy path for fluid around the short rod plunger 70, movement of the assembly is rapid and fluid emits from the nozzle. This restriction creates sufficient time delay for the tap holder to stop spinning prior to the fluid being ejected from the tap holder.

What is claimed is:

1. On a machining center of the type in which a rotating cutter is moved in relation to a work piece to selectively cut material from that work piece:
(a) device is envisioned which harnesses the rotational motion generally used to cut material from the work piece,
(b) Energy harnessed from rotational motion is used to grip a work piece.

2. The mechanism of claim 1 where the quantity of grip on said work piece is dependent on the rotary position that the spindle of said machining center is indexed to.

3. The mechanism of claim 1 where spindle rotary motion is directly related to the grip on the work piece and altering spindle speed alters the quantity of grip on the work piece.

4. The mechanism of claim 1 where spindle rotary motion is directly related to the grip on the work piece and the work piece is gripped or released dependent on whether the spindle is stopping or rotating.

5. The mechanism of claim 1 where spindle rotary motion is directly related to the grip on the work piece and the work piece is griped or released dependent on the direction of spindle motion.

6. The mechanism of claim 1 where spindle rotary motion is directly related to the grip on the work piece and the quantity of force gripping the work piece is dependent on the rotational speed of the spindle.

7. Where a tool holder is used to hold a cutting tool and the combination of tool holder and cutting tool is rotated to enable the cutting tool to remove material from a work piece:
(a) the tool holder is equipped with a fluid containing reservoir,
(b) when the tool holder is rotated to a sufficient speed before being stopped fluid from the reservoir is emitted from the tool holder.
(c) The tool holder of claim 7 where one or more adjustable members is used to distribute fluid to a particular portion or multiple areas of a cutting tool held in the tool holder.
